(19) United States
(12) Patent Application Publication
(10) Pub. No.: US 2026/0219642 A1
(43) Pub. Date: Jul. 30, 2026

(54) CONTROLLING A LOW-VOLTAGE SMART SWITCH BASED ON ENVIRONMENTAL CONDITIONS

(71) Applicant: Swift Beat, LLC, Menlo Park, CA (US)

(72) Inventors: Kevin Lee PHELPS, Alexandria, VA (US); Jonathan Louis MILLAN, Windermere, FL (US)

(21) Appl. No.: 19/460,287

(22) Filed: Jan. 26, 2026

Related U.S. Application Data
(60) Provisional application No. 63/750,263, filed on Jan. 27, 2025.

(51) Int. Cl. G05B 15/02

(52) U.S. Cl. CPC G05B 15/02

(57) ABSTRACT

Systems and methods are provided for controlling activation of a low-voltage switch. In response to a triggering event, one or more pre-activation safety checks are performed prior to applying a low voltage. Environmental condition data associated with an apparatus is obtained from one or more sensors and evaluated against corresponding threshold criteria. Based on the evaluation, the low-voltage switch is placed in either a ready state or a non-ready state. Upon receipt of an activation signal requesting application of the low voltage, the low-voltage switch is activated when in the ready state, and activation is inhibited when in the non-ready state.

### CROSS-REFERENCE TO RELATED APPLICATION

This application claims the benefit of U.S. Provisional Application No. 63/750,263, filed Jan. 27, 2025, the entirety of which is hereby incorporated by reference herein.

### BACKGROUND

The field of control systems for high-voltage and high-rate switching applications often relies on monolithic architecture, and proprietary or single-source components or technology. However, when transitioning to a low-voltage system, maintaining signal integrity and communication reliability can be challenging, particularly in dynamic environments with electrical noise or fluctuations. This can make it difficult to ensure precise and stable sensor readings or control commands, potentially impacting responsiveness, reliability, and accuracy of a system.

### SUMMARY

This Summary is provided to introduce a selection of concepts in a simplified form that are further described below in the Detailed Description. This Summary is not intended to identify key features or essential features of the claimed subject matter, nor is it

intended to be used to limit the scope of the claimed subject matter. Nor is the claimed subject matter limited to implementations that solve any or all of the disadvantages noted herein.

Systems and methods for controlling a low-voltage switch are provided. Based on a triggering event, pre-activation safety checks are initiated prior to activating a low-voltage switch. An environmental condition associated with an apparatus is received from a sensor or a plurality of sensors. The environmental conditions are compared to thresholds and based on the comparison, the low-voltage switch is either placed in a ready state or in a non-ready state; An activation signal comprising a command for the low-voltage switch to apply a low voltage is received, and based on receipt of the activation signal: when the low-voltage switch is in a ready state, the low-voltage switch is activated; and when the low-voltage switch is in a non-ready state, the activation signal is rejected by not activating the low-voltage switch.

### BRIEF DESCRIPTION OF THE DRAWINGS

The present description will be better understood from the following detailed description read considering the accompanying drawings, wherein:

FIG. 1 is a block diagram illustrating an example system configured for controlling a smart switch based on environmental conditions;

FIG. 2 is a block diagram illustrating an example system configured for controlling a low-voltage switch based on environmental conditions;

FIGS. 3 and 4 are flowcharts illustrating example methods for controlling a low-voltage switch based on environmental conditions;

FIG. 5 is a block diagram of an example computing apparatus for implementing examples of the present disclosure.

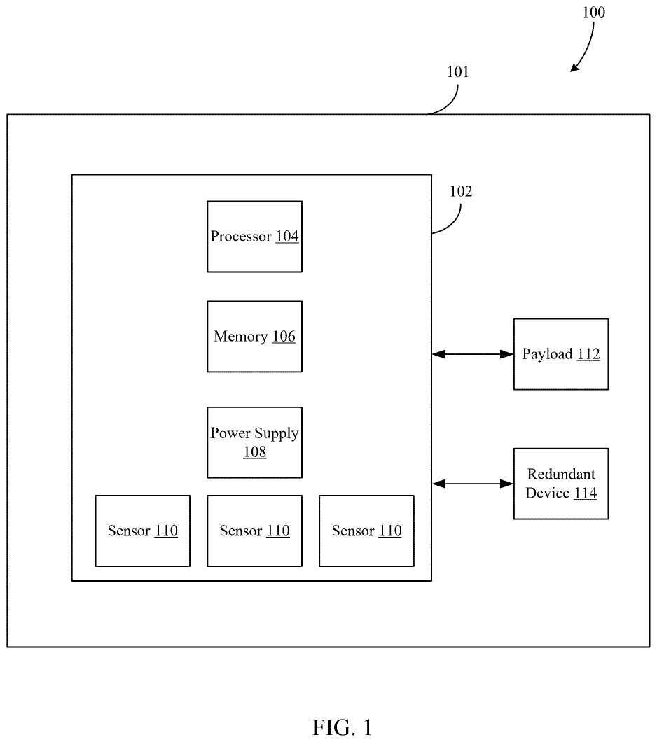

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

Conventional switching mechanisms lack the capability to effectively integrate and respond to complex environmental inputs. In examples involving mobile platforms, the ability to interpret environmental data such as air speed, acceleration, and other external factors from sensors like barometers and accelerometers is essential for maintaining safe and effective operation.

Further, conventional systems typically encompass a limited scope of sensor capabilities. This conventional approach constrains adaptability and precision when controlling switches outside of high-voltage contexts.

Another shortcoming in conventional systems is the inadequate implementation of redundancy and validation steps in switching processes for safety critical systems. Conventional systems do not provide sufficient safeguards to prevent unintentional switching, and often lack comprehensive multi-layered validation processes that independently verify system readiness. This limitation increases the risk of accidental switching, which could pose a safety hazard. The absence of robust logic systems to manage and safeguard the switching sequence based on real-time environmental data further accentuates these risks.

In contrast, aspects of the disclosure include a low-voltage switching system. The system implements a smart switch with an ability to operate effectively at low voltage levels by integrating a range of environmental data inputs to ensure safe operating conditions and employing a multi-step validation process with built-in redundancy. In example implementations such as a mobile platform, the smart switch is configured to interpret environmental conditions, such as air speed, acceleration, and data from various external sensors like barometers and accelerometers in real time. Additionally, the smart switch controls voltage application based on the environmental conditions and ensures safety through dual system verification to confirm readiness. These improvements offer customization, adaptability, and safety across various low voltage operational scenarios where traditional high voltage safety standards or devices may not suffice.

Aspects of the disclosure are operable in a wide range of applications, such as automotive airbag deployment, emergency escape systems (e.g., ejection seats, parachutes, etc.), and aerial resupply and airdrop deployment. In an airbag deployment example, the smart switch provides a low voltage that ignites a small explosive charge to inflate the airbag upon verification that one or more environmental conditions have been met that are specific to airbag deployment. In an emergency escape system, the smart switch provides a low voltage that ignites small charges to propel or deploy safety mechanisms upon verification that one or more environmental conditions have been met that are specific to, for example, an ejection seat or parachute. In aerial resupply and airdrop deployment, the smart switch provides a low voltage that ignites small pyrotechnic charges that perform a deployment of supplies upon verification that one or more environmental conditions have been met that are specific to aerial resupply and airdrop deployment.

While some examples are described for convenience in the context of a single low-voltage smart switch, aspects of the disclosure also include an environmental board that is operable with any quantity of low-voltage switches. For example, the environmental board is operable to control two or more low-voltage switches, wherein each of the low-voltage switches are controlled to separately suit specific applications and requirements. In some examples, each low-voltage switch has distinct environmental conditions for activation, tailored to the specific operational parameters and functions of each low-voltage switch.

An example technical effect of the described smart switch is to enable a switching process that adheres to low-voltage safety principles while integrating a comprehensive array of environmental data inputs. In an example implementation in a mobile platform, this system enhances precision in determining safe operating conditions by leveraging environmental conditions such as air speed, acceleration, altitude, velocity, acceleration, time lapse after a trigger event, location information, ground speed, wind speed, humidity, temperature, and battery life, allowing for a response to various environmental factors. Additionally, an incorporation of a multi-step validation process with built-in redundancy ensures independent confirmations of readiness, significantly mitigating the risk of unintentional switching.

Example technical advantages of using low voltage over high voltage in the context of a control system such as the described environment board include, for example: safety and compliance, reduced equipment wear and reliability, miniaturization and portability, energy usage optimization, and compatibility.

With respect to safety and compliance, the smart switch and/or environmental board implementing low-voltage mechanisms reduces a risk of electrical hazards, thus enhancing safety for both operators and equipment enabling safer operations across various environments.

With respect to reduced equipment wear and reliability, the smart switch and/or environmental board implementing low-voltage mechanisms lead to reduced wear and tear on electronic components at least because lower electrical stress is exerted. This contributes to improved reliability and extended lifespan of the equipment, translating into fewer maintenance needs and potential cost savings over time.

With respect to miniaturization and portability, the smart switch and/or environmental board implementing low-voltage mechanisms allow for greater design flexibility in terms of size and form factor, facilitating a development of more compact and portable equipment. This is particularly beneficial in applications such as mobile platforms or portable safety systems, where space and weight are critical considerations.

With respect to energy usage optimization, the smart switch and/or environmental board implementing low-voltage mechanisms achieve higher energy efficiency, especially when integrated with power management techniques designed specifically for low power consumption. This results in longer operational life for battery-powered systems and reduced operational costs for energy-intensive applications.

With respect to compatibility, the smart switch and/or environmental board implementing low-voltage mechanisms are more compatible with modern microcontrollers and digital components that are optimized for low-voltage operations, ensuring that the smart switch and/or environmental board can more easily integrate with state-of-the-art technologies. This compatibility enhances a potential for customization and technological advancement in low-voltage applications.

Referring to the figures, FIG. 1 is a block diagram illustrating an example system 100 is provided. The system 100 includes an apparatus 101 (e.g., a mobile platform or stationary platform), a smart switch 102 (e.g., an environmental board), a processor 104, a memory 106, a power supply 108, a plurality of sensors 110, a payload 112, and a redundant device 114.

In some examples, the smart switch 102 is configured to apply a low voltage to the payload 112 upon a determination that one or more environmental conditions have been met. In some examples, the low voltage applied by the smart switch 102 is less than 500 volts. In some examples, the low voltage applied by the smart switch 102 is less than 100 volts. In some examples, the low voltage applied by the smart switch 102 is less than 50 volts. In some examples, the low voltage applied by the smart switch 102 is less than 13 volts, for example, between 3.3 volts to 12 volts. These voltages provide an effective operational framework for the system 100, facilitating precise control of a ready state (e.g., arming) sequences while maintaining compliance with safety standards designed for low-voltage applications. Further, this low voltage range supports the intelligent switching capabilities of the smart switch 102, enabling the smart switch 102 to interact with corresponding sensors, general purpose input output (GPIO) interfaces, and other components essential to control functions of the smart switch 2012, while ensuring the safety and stability of the system 100 during operation.

In some examples involving detonation, the smart switch 102 performs a comprehensive check before arming itself to ensure that a detonation of the payload 112 does not compromise safety, execute pre-maturely, and/or in adverse conditions. In some examples, the comprehensive check includes obtaining environmental information/date from the plurality of sensors 110. In some examples, a sensor from the plurality of sensors 110 of the apparatus 101 includes a pressure sensor, temperature sensor, humidity sensory, pilot tubes, angle of attack sensor, wind sensor, radar systems, light detection and ranging (LIDAR), lightning sensor, forward-looking infrared, cameras, ice detectors, infrared sensor, ultraviolet sensor, cosmic ray detector, magnetometer, particulate detector, carbon dioxide sensor, ozone sensor, global positional satellite, inertial navigation, acoustic sensor, vibration sensor, and a clock.

In some examples, the smart switch 102 receives environmental conditions from the plurality of sensors 110. In some examples, the smart switch 102 is configured to interpret the environmental conditions associated with the apparatus 101 (e.g., air speed, setback acceleration, altitude, velocity, acceleration, time lapse after a trigger event, location information, ground speed, wind speed, humidity, temperature, and/or battery life) in real time. The smart switch 102 compares the environmental conditions from the plurality of sensors with thresholds stored in the memory 106. In some examples, the thresholds stored in the memory 106 are tailored to specific operational parameters and functions of the smart switch 102. For example, when the smart switch 102 is used to deploy a parachute, the environmental conditions and corresponding thresholds are different than if the smart switch 102 is being used to deploy an airbag in an automobile, or an application wherein the apparatus 101 is in outer space or under water.

In some examples, the smart switch 102 transitions from a non-ready state to a ready state when the smart switch 102 determines that the environmental conditions are satisfied. In some examples, only one environmental condition is needed for the smart switch 102 to transition from a non-ready state to a ready state. In some examples, the smart switch 102 maintains a non-ready state when the smart switch 102 determines that the environmental conditions are not satisfied. In some examples, all the environmental conditions must be satisfied for the smart switch 102 to confirm that the environmental conditions are satisfied such that the smart switch 102 transitions from a non-ready state to a ready state. In some examples, only a subset of the environmental conditions need to be satisfied for the smart switch 102 to confirm that the environmental conditions are satisfied such that the smart switch 102 transitions from a non-ready state to a ready state.

In some examples, the environmental conditions are compared to the corresponding thresholds as soon as the environmental conditions are received by the smart switch 102 (e.g., in real time). In some examples, the environmental conditions are obtained and stored in the memory 106, and thereafter, determine to be satisfied or not satisfied at a defined time or upon receipt of a triggering event. In some examples, the environmental conditions are determined to be satisfied or not satisfied in stages and/or in a particular order. For example, when the apparatus 101 is a mobile platform, a first environmental condition is power on detection, a second environmental condition is a particular altitude, and a third environmental condition is air speed. Thus, in this example, the power-on detection is confirmed prior to altitude and air speed. In some examples, the power-on detection triggers initializing an activation of a plurality of sensors (e.g., the sensors that determine altitude and air speed), and thereafter causing a calibration of sensor outputs for the plurality of sensors according to predefined parameters (e.g., predefined parameters stored in the memory 106).

In some examples, after the smart switch 102 has either determined to transition to a ready state or maintain a non-ready state, the redundancy device 114, which is separate (e.g., independent) from the smart switch 102, compares the environmental conditions with the corresponding thresholds to either confirm or reject the determination made by the smart switch 102 to either transition to a ready state or maintain a non-ready state. As such, an incorporation of a multi-step validation process with built-in redundancy of the redundancy device 114 ensures independent confirmations of readiness, significantly mitigating the risk of unintentional switching. In some examples, when the smart switch 102 is in the ready state, energy/voltage is generated by the power supply 108 or generated by the smart switch 102 and stored on the power supply 108 (e.g., a capacitor) to enable a proper amount of voltage to be quickly applied when a triggering event takes place. In some examples, the triggering event is an indication that each of the environmental conditions are met. In another example, when the apparatus 101 is a mobile platform, a triggering event is when the mobile platform gets near to or hits a target, causing a release of the low voltage into the payload 112 or a detonator (not shown) which initiates the payload 112 to detonate.

In some examples, the smart switch 102 receives an activation signal that includes a command for the smart switch 102 to apply a low voltage to the payload 112. Upon receipt of the activation signal, the smart switch 102 is either in a ready state or a non-ready state (e.g., based on the environmental conditions). In some examples, when the activation signal is received by the smart switch 102 when the smart switch 102 is in the ready state, the smart switch 102 automatically provides a low voltage. In some examples, the smart switch 102 automatically provides the low voltage to the payload 112, causing a detonation of the payload 112. In some examples, prior to the low voltage detonating the payload 112, an integrity of a source of the low voltage is determined by evaluating an origin of the low voltage through integrated control logic. This prevents unauthorized external control or tampering by continuously assessing an integrity of the voltage source, employing security protocols that also detect discrepancies in an expected voltage path or level. This precaution helps in maintaining secure and autonomous control over a switching process, minimizing the risk of external manipulation.

In some examples, if the voltage received by the payload 112 is higher than an expected voltage, the smart switch 102 enters a fail-safe mode to prevent any potential unsafe conditions. The smart switch 102 includes protection mechanisms to detect and respond to voltage levels that exceed predefined safe operational parameters. For example, when high voltage is detected (e.g., a voltage exceeding an expected voltage or a voltage over a threshold, such as 500 volts), these mechanisms trigger the smart switch 102 to default to a non-ready or safe state, effectively deactivating the smart switch 102 and preventing unintentional switching (e.g., application of a low voltage to the payload 112). This fail-safe feature aligns with compliance requirements for both low-voltage and high-voltage safety standards, ensuring that the system 100 consistently prioritizes safety in varying voltage environments. The redirecting of the smart switch 102 to a safe state (e.g., non-ready state) upon high voltage detection minimizes a risk of accidental activation and maintaining operational safety.

In some examples, when the activation signal is received by the smart switch 102 when the smart switch 102 is in the non-ready state, the smart switch 102 automatically rejects/ignores the activation signal, and as such, does not provide a low voltage as requested.

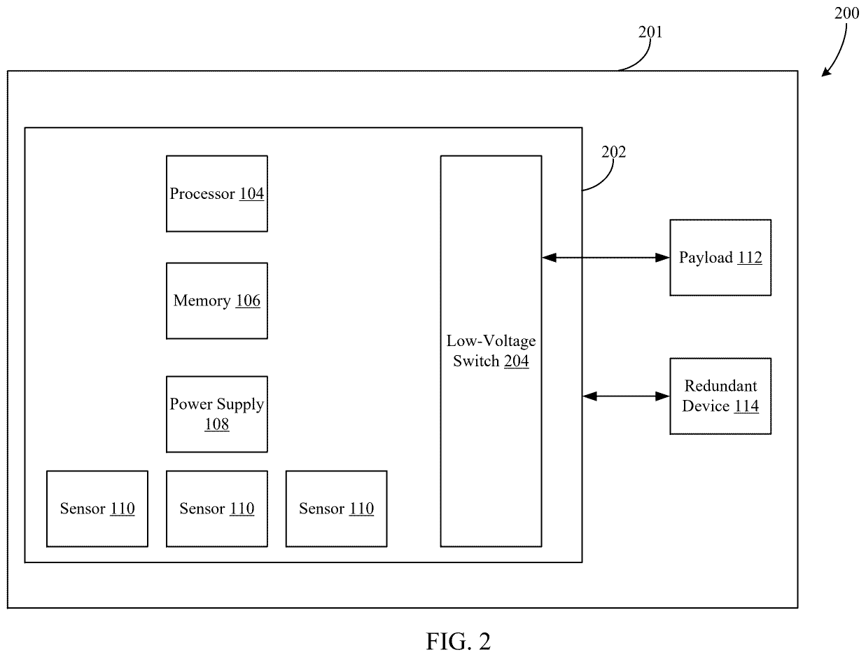

With reference now to FIG. 2, a system 200 comprising an environmental board 202 is provided. In some examples, the system 200 includes an apparatus 201, a low-voltage switch 204 (e.g., a smart switch), the processor 104, the memory 106, the power supply 108, the plurality of sensors 110, the payload 112, and the redundant controller 114. As shown in FIG. 2, the environmental board 202 includes the low-voltage switch 204. In some examples, the low-voltage switch 204 is in communication with, but is separate from, the environmental board 202 while the processor 104, the memory 106, the power supply 108, the plurality of sensors 110, the payload 112, and the redundant controller 114 are the same as shown in FIG. 1.

In some examples, the environmental board 202 performs a comprehensive check before transitioning the low-voltage switch 204 from a non-ready state to a ready state to ensure that switching (e.g., detonation of the payload 112) does not compromise safety, execute pre-maturely, and/or execute in adverse conditions. In some examples, the comprehensive check includes obtaining environmental information/date from the plurality of sensors 110.

In some examples, the environmental board 202 receives environmental conditions (e.g., environmental conditions associated with the apparatus 201) from the plurality of sensors 110. In some examples, the environmental board 202 is configured to interpret the environmental conditions in real time. The environmental board 202 compares the environmental conditions from the plurality of sensors 110 with thresholds stored in the memory 106.

In some examples, the environmental board 202 transitions the low-voltage switch 204 from a non-ready state to a ready state when the environmental board 202 determines that the environmental conditions are satisfied. In some examples, only one environmental condition is needed for the environmental board 202 to transition the low-voltage switch 204 from a non-ready state to a ready state. In some examples, the environmental board 202 maintains the low-voltage switch 204 in a non-ready state when the environmental board 202 determines that the environmental conditions are not satisfied. In some examples, all the environmental conditions must be satisfied for the environmental board 202 to confirm that the environmental conditions are satisfied such that the environmental board 202 transitions the low-voltage switch 204 from a non-ready state to a ready state. In some examples, only a subset of the environmental conditions is needed to be satisfied for the environmental board 202 to confirm that the environmental conditions are satisfied such that the environmental board 202 transitions the low-voltage switch 204 from a non-ready state to a ready state.

In some examples, the environmental conditions are compared to the corresponding thresholds as soon as the environmental conditions are received by the environmental board 202 (e.g., in real time). In some examples, the environmental conditions are obtained and stored in the memory 106, and thereafter, determined to be satisfied or not satisfied at a defined time or upon receipt of a triggering event. In some examples, the environmental conditions are determined to be satisfied or not satisfied in stages and/or in a particular order. For example, when the apparatus 201 is a mobile platform, a first environmental condition is power on detection, a second environmental condition is a particular altitude, and a third environmental condition is air speed. Thus, in this example, the power-on detection is confirmed prior to altitude and air speed. In some examples, the power-on detection triggers initializing an activation of a plurality of sensors (e.g., the sensors that determine altitude and air speed), and thereafter causing a calibration of sensor outputs for the plurality of sensors according to predefined parameters (e.g., predefined parameters stored in the memory 106).

In some examples, after the environmental board 202 has either determined to transition the low-voltage switch 204 to a ready state or maintain the low-voltage switch 204 in a non-ready state, the redundancy device 114, which is separate (e.g., independent) from the smart switch 102, compares the environmental conditions with the corresponding thresholds to either confirm or reject the determination made by the environmental board 202 either to transition to a ready state or maintain a non-ready state. As such, an incorporation of a multi-step validation process with built-in redundancy of the redundancy device 114 ensures independent confirmations of readiness, significantly mitigating the risk of unintentional switching.

In some examples, the environmental board 202 receives an activation signal that includes a command for the environmental board 202 to activate the low-voltage switch 204 such that the low-voltage switch 204 applies a low voltage. In some examples, the activation signal includes a command for the environmental board 202 to activate the low-voltage switch 204 such that the low-voltage switch 204 applies a low voltage to the payload 112. Upon receipt of the activation signal, the low-voltage switch 204 is either in a ready state or a non-ready state (e.g., based on the environmental conditions). In some examples, when the activation signal is received by the environmental board 202 when the low-voltage switch 204 is in the ready state, the low-voltage switch 204 automatically provides a low voltage. In some examples, the low-voltage switch 204 automatically provides the low voltage to the payload 112, causing a detonation of the payload 112. In some examples, prior to a low voltage being applied to the payload 112, an integrity of a source of the low voltage is determined by evaluating an origin of the low voltage through integrated control logic.

In some examples, when the activation signal is received by the environmental board 202 when the low-voltage switch 204 is in the non-ready state, the environmental board 202 automatically rejects or ignores the activation signal.

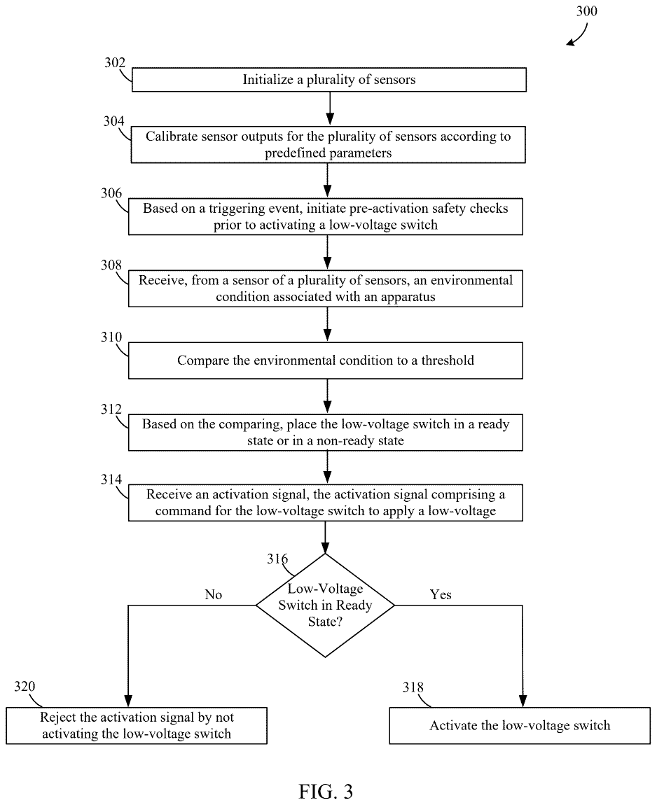

With reference now to FIG. 3, a flowchart illustrating an example of a method 300 of operations, functions, and/or the like of the system 100 (FIG. 1) and/or the system 200 (FIG. 2). At 302, a plurality of sensors (e.g., the plurality of sensors 110) are initialized and activated. In some examples, a sensor from the plurality of sensors 110 includes a pressure sensor, temperature sensor, humidity sensory, pilot tubes, angle of attack sensor, wind sensor, radar systems, light detection and ranging (LIDAR), lightning sensor, forward-looking infrared, cameras, ice detectors, infrared sensor, ultraviolet sensor, cosmic ray detector, magnetometer, particulate detector, carbon dioxide sensor, ozone sensor, global positional satellite, inertial navigation, acoustic sensor, vibration sensor, and a clock.

In some examples, the apparatus 201 includes the plurality of sensors 110. In this example, the plurality of sensors 110 are initialized and activated after the UAV powers on. In another example, the plurality of sensors 110 are initialized and active after a triggering event, such as the apparatus 201 being airborne for a defined period of time. At 304, based on a determination that the plurality of sensors 110 is activated, outputs for the plurality of sensors 110 are calibrated according to predefined parameters stored in the memory 106.

At 306, based on a triggering event being detected, pre-activation safety checks are initiated prior to activating a low-voltage switch (e.g., the low-voltage switch 204). In some examples, the triggering event is a power-on of, for example, the apparatus 201. In another example, the triggering event is a period of time expiring after the power-on of the apparatus 201, an indication that the apparatus 201 is airborne, a request from a user, a particular altitude of the apparatus 201, a particular air speed of the apparatus 201, and/or a particular location of the apparatus 201.

At 308, an environmental condition associated with the apparatus 201 (e.g., an uncrewed aerial vehicle (UAV)) is received from a sensor of the plurality of sensors 110. In some examples, an environmental condition is received from each of the plurality of sensors 110. In some examples, an environmental condition is one or more of the following: air speed, setback acceleration, altitude, velocity, acceleration, time lapse after a trigger event, location information, ground speed, wind speed, humidity, temperature, and battery life.

At 310, the environmental condition(s) is compared to a threshold (e.g., a threshold stored in the memory 106). At 312, based on the comparing, the low-voltage switch is placed in a ready state or in a non-ready state. In some examples, steps 308-312 are repeated continuously (e.g., in a loop) to ensure real-time monitoring and evaluation of environmental conditions, enabling the system described herein to respond promptly to changes and maintain the required operational safety standards throughout the switching procedures (e.g., activation/detonation procedures). At 314, an activation signal is received. In some examples, the activation signal includes a command for the low-voltage switch 204 to apply a low voltage. In some examples, the low voltage is between 3.3 volts to 12 volts. At 316, based on receipt of the activation signal, a determination is made as to whether the low-voltage switch 204 is in a ready state. At 318, when the low-voltage switch is in a ready state, the low-voltage switch 204 is activated causing the low-voltage switch to provide the low voltage. At 320, when the low-voltage switch is in a non-ready state, the activation signal is rejected by not activating the low-voltage switch 204. In some examples, prior to activating the low-voltage switch 204, confirming, from a secondary device (e.g., the redundant device 114), that the secondary device has determined to place the low-voltage switch in the ready state or in the non-ready state. Thus, when the redundant device 114 confirms the determination made in step 312, the low-voltage switch is placed in the ready state or in the non-ready state as determined in step 312. In contrast, when the redundant device 114 does not confirm the determination made in step 312, the low-voltage switch is placed in the non-ready state. In some examples, prior to activating the low-voltage switch 204, an integrity of a source of the low voltage is assessed by evaluating an origin of the low voltage through integrated control logic. In this example, if the source of the low voltage is not from the low-voltage switch 204, the process is terminated and a payload (e.g., the payload 112) is detonated.

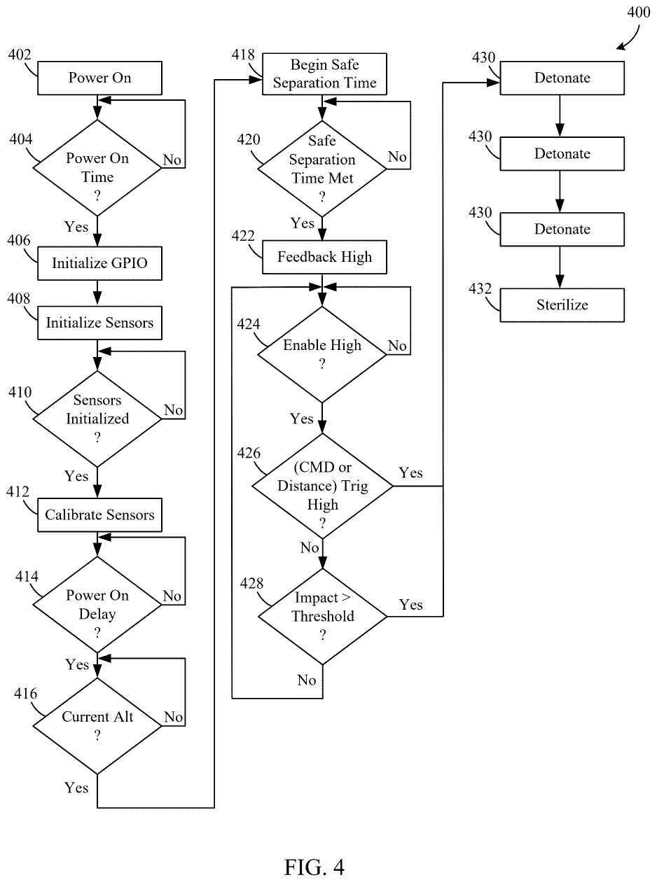

With reference now to FIG. 4, a flowchart illustrates a logical sequence of operations for the system 100 (FIG. 1) and/or the system 200 (FIG. 2) that illustrate the robustness of system's checks and balances designed to govern safe and reliable operation.

The process begins with a “Power On” step at 402, initiating a sequence that confirms “Power On Time” at 404. In some examples, the power on is with respect to an apparatus (e.g., a mobile or stationary platform) that includes the smart switch 102 or the environmental board 202. Once power stability is verified, the process proceeds to “Initialize GPIO” (General-Purpose Input/Output) at 406 setting up the general-purpose input/output interfaces necessary for sensor integration.

Subsequently, the process moves to “Initialize Sensors” at 408 where a plurality of sensors (e.g., the plurality of sensors 110) are activated. At 410, a decision is made as to whether the plurality of sensors 110 are initialized, which ensures the plurality of sensors 110 are fully functional before advancing to “Calibrate Sensors” at 412, which adjusts outputs of the plurality of sensors 110 according to predefined parameters. Following calibration, the process continues to “Power On Delay” decision at 414, allowing time for stabilization of the system's components. Once the delay has elapsed, a “Current Alt” is verified at 416 ensuring the apparatus is at the correct altitude for safe activation.

The process proceeds to “Begin Safe Separation Time” at 418, which starts a timing sequence for maintaining safe operation distances. At 420, “Safe Separation Time Met” decision checks if a safety separation time buffer has elapsed. If affirmed, the process continues to “Feedback High” at 422, which serves as a check for confirming readiness for the next stages. A decision “Enable High?” at 424 ensures that all conditions and permissions from a logic system align before validating whether “(cmd or distance) Trig High?” conditions are met at 426, where potential trigger commands or distance thresholds are assessed. Upon meeting these criteria, the process continues to 428 where a decision is made with respect to “Impact>Threshold?” to confirm whether impact conditions exceed predefined safe levels. If confirmed, the process continues to the “Detonate” stage at 430. This detonation sequence 430 is repeated multiple times (e.g., two or more times), to ensure completion, followed by “Sterilize” at 432, which is a step that safely neutralizes the system to prevent any unintended activation post-operation.

### Exemplary Operating Environment

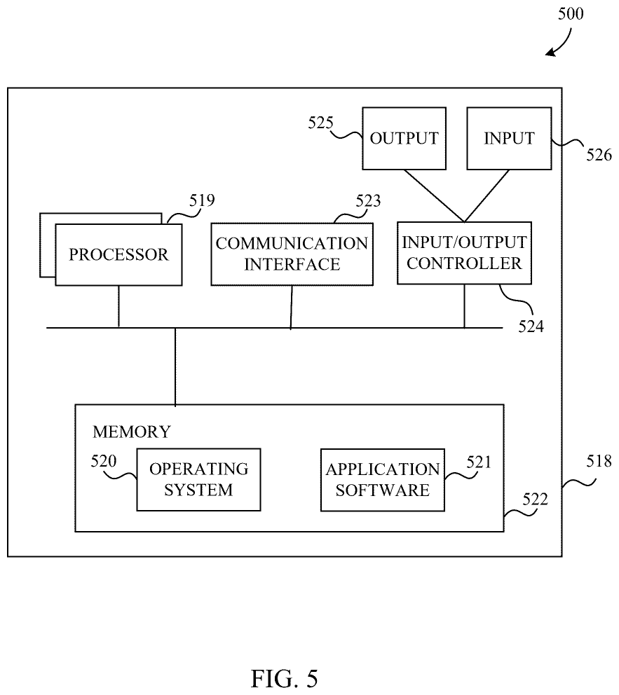

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the computing apparatus 518 to enable application software 521 to be executed on the device.

In some examples, computer executable instructions are provided using any computer-readable media that is accessible by the computing apparatus 518. Computer-readable media include, for example, computer storage media and communications media. Computer storage media, such as the memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display (e.g., displaying a GUI) or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” ”one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A computerized method for controlling activation of a low-voltage switch on a mobile platform, the method comprising:
detecting a triggering event associated with the mobile platform, the mobile platform being in a non-ready state;
based on the triggering event, initiating a pre-activation safety check;
receiving, from a sensor of a plurality of sensors, an environmental condition associated with the mobile platform;
comparing the environmental condition to a threshold;
based on the comparing:
when the threshold is met, transitioning the low-voltage switch from the non-ready state to a ready state; and
when the threshold is not met, maintaining the low-voltage switch in the non-ready state;
receiving an activation signal, the activation signal comprising a command for the low-voltage switch to apply a low voltage; and
based on receipt of the activation signal:
when the low-voltage switch is in the ready state, activating the low-voltage switch; and
when the low-voltage switch is in the non-ready state, rejecting the activation signal by not activating the low-voltage switch.

2. The method according to claim 1, wherein the environmental condition comprises one or more of the following: air speed, setback acceleration, altitude, velocity, acceleration, time lapse after a trigger event, location information, ground speed, wind speed, humidity, temperature, and battery life.

3. The method according to claim 1, further comprising: prior to activating the low-voltage switch, confirming, from a secondary device, that the secondary device has also determined to transition the low-voltage switch from the non-ready state to the ready state.

4. The method according to claim 1, wherein the low voltage is between 3.3 volts and 12 volts.

5. The method according to claim 1, further comprising:
prior to activating the low-voltage switch, assessing an integrity of a source of the low voltage by evaluating an origin of the low-voltage through integrated control logic.

6. The method according to claim 1, further comprising:
receiving, from a second sensor of the plurality of sensors, a second environmental condition associated with the mobile platform;
comparing the second environmental condition to a second threshold; and
based on comparing the environmental condition to the threshold and the second environmental condition to the second threshold:
when the threshold and the second threshold are met, transitioning the low-voltage switch from the non-ready state to the ready state; and
when one of the threshold and the second threshold is not met, maintaining the low-voltage switch in the non-ready state.

7. The method according to claim 1, further comprising:
prior to receiving the environmental condition from the sensor of the plurality of sensors:
initializing the plurality of sensors; and
based on a determination that the plurality of sensors is activated, calibrating sensor outputs for the plurality of sensors according to predefined parameters.

8. A system comprising:
an apparatus;
a plurality of sensors; and
an environment board comprising:
a low-voltage switch in a non-ready state;
a processor; and
a memory comprising computer-executable instructions that, when executed by the processor, cause the processor to perform the following operations:
detecting a triggering event associated with the apparatus;
based on the triggering event, initiating a pre-activation safety check;
receiving, from a sensor of the plurality of sensors, an environmental condition associated with the apparatus;
comparing the environmental condition to a threshold;
based on the comparing:
when the threshold is met, transitioning the low-voltage switch from the non-ready state to a ready state; and
when the threshold is not met, maintaining the low-voltage switch in the non-ready state;
receiving an activation signal, the activation signal comprising a command for the low-voltage switch to apply a low voltage; and
based on receipt of the activation signal:
when the low-voltage switch is in the ready state, activating the low-voltage switch; and
when the low-voltage switch is in the non-ready state, rejecting the activation signal by not activating the low-voltage switch.

9. The system according to claim 8, wherein the environmental condition comprises one or more of the following: air speed, setback acceleration, altitude, velocity, acceleration, time lapse after a trigger event, location information, ground speed, wind speed, humidity, temperature, and battery life.

10. The system according to claim 8, wherein the computer-executable instructions further cause the processor to perform the following operations:
prior to activating the low-voltage switch, confirming, from a secondary device, that the secondary device has also determined to transition the low-voltage switch from the non-ready state to the ready state.

11. The system according to claim 8, wherein the low voltage is between 3.3 volts and 12 volts.

12. The system according to claim 8, wherein the computer-executable instructions further cause the processor to perform the following operations:
prior to activating the low-voltage switch, assessing an integrity of a source of the low voltage by evaluating an origin of the low-voltage through integrated control logic.

13. The system according to claim 8, wherein the computer-executable instructions further cause the processor to perform the following operations:
receiving, from a second sensor of the plurality of sensors, a second environmental condition associated with the apparatus;
comparing the second environmental condition to a second threshold; and
based on comparing the environmental condition to the threshold and the second environmental condition to the second threshold:
when the threshold and the second threshold are met, transitioning the low-voltage switch from the non-ready state to the ready state; and
when one of the threshold and the second threshold is not met, maintaining the low-voltage switch in the non-ready state.

14. The system according to claim 8, wherein the computer-executable instructions further cause the processor to perform the following operations:
prior to receiving the environmental condition from the sensor of the plurality of sensors:
initializing the plurality of sensors; and
based on a determination that the plurality of sensors is activated, calibrating sensor outputs for the plurality of sensors according to predefined parameters.

15. A non-transitory computer-readable medium comprising computer-executable instructions that, when executed by a processor, cause the processor to perform the following operations:
detecting a triggering event associated with an apparatus;
based on the triggering event, initiating a pre-activation safety check;
receiving, from a sensor of a plurality of sensors, an environmental condition associated with the apparatus;
comparing the environmental condition to a threshold;
based on the comparing:
when the threshold is met, transitioning the low-voltage switch from the non-ready state to a ready state; and
when the threshold is not met, maintaining the low-voltage switch in the non-ready state;
receiving an activation signal, the activation signal comprising a command for the low-voltage switch to apply a low voltage; and
based on receipt of the activation signal:
when the low-voltage switch is in the ready state, activating the low-voltage switch; and
when the low-voltage switch is in the non-ready state, rejecting the activation signal by not activating the low-voltage switch.

16. The non-transitory computer-readable medium according to claim 15, wherein the environmental condition comprises one of the following: air speed, setback acceleration, altitude, velocity, acceleration, time lapse after a trigger event, location information, ground speed, wind speed, humidity, temperature, and battery life.

17. The non-transitory computer-readable medium according to claim 15, wherein the computer-executable instructions further cause the processor to perform the following operations:
prior to activating the low-voltage switch, confirming, from a secondary device, that the secondary device has also determined to place the low-voltage switch in the ready state.

18. The non-transitory computer-readable medium according to claim 15, wherein the low voltage is between 3.3 volts and 12 volts.

19. The non-transitory computer-readable medium according to claim 15, wherein the computer-executable instructions further cause the processor to perform the following operations:
prior to activating the low-voltage switch, assessing an integrity of a source of a low-voltage by evaluating an origin of the low-voltage through integrated control logic.

20. The non-transitory computer-readable medium according to claim 15, wherein the computer-executable instructions further cause the processor to perform the following operations:
initializing the plurality of sensors;
based on a determination that the plurality of sensors is activated, calibrating sensor outputs for the plurality of sensors according to predefined parameters;
receiving, from a second sensor of the plurality of sensors, a second environmental condition associated with the mobile platform;
comparing the second environmental condition to a second threshold; and
based on comparing the environmental condition to the threshold and the second environmental condition to the second threshold:
when the threshold and the second threshold are met, transitioning the low-voltage switch from the non-ready state to the ready state; and
when one of the threshold and the second threshold is not met, maintaining the low-voltage switch in the non-ready state.
